(19) United States
(12) Patent Application Publication
(10) Pub. No.: US 2006/0107484 A1
(43) Pub. Date: May 25, 2006

(54) SURFACE FINISHING TOOL FOR FLAT, CURVED, OR RADIUS WALLS

(76) Inventor: Curtis R. Borden III., Loxahatchee, FL (US)

Correspondence Address: JOHN C. SMITH, ESQ., 2499 GLADES ROAD, SUITE 113, BOCA RATON, FL, 33431, US

(21) Appl. No.: 10/908,150

(22) Filed: Apr. 28, 2005

Related U.S. Application Data
(60) Provisional application No. 60/522,919, filed on Nov. 19, 2004.

(51) Int. Cl. B05C 17/10

(52) U.S. Cl. 15/235.5

(57) ABSTRACT

A surface finishing tool that uses a flexible extended blade with handles at either end to finish a variety of wall structures. The blade is sufficiently flexible to allow it to be deformed to float acute radius wall surfaces, or deformed in the opposite direction to allow it to float obtuse radius wall surfaces where two walls meet, to float irregular wall surfaces, or to float columns. Alternative structures provide the ability to replace the extended blade with other blades having a variety of edge finishes, or to add removable edge finishes. The edge finishes provide the workmen with the ability to rapidly install custom surface finishes on large walls. An optional rigid support brace holds the extended blade in a linear configuration for floating flat surfaces.

### CROSS-REFERENCE TO RELATED APPLICATIONS

This application is related to, and claims the benefit of, the provisional patent application entitled “Surface Finishing Tool for Flat, Curved, or Radius Walls,” filed Nov. 19, 2004, bearing U.S. Ser. No. 60/522,919 and naming Curtis R. Borden, III, the named inventor herein, as sole inventor, the contents of which is specifically incorporated by reference herein in its entirety.

### BACKGROUND OF THE INVENTION

1. Technical Field

The present invention relates to plaster, cement, stucco, and/or drywall installation and repair tools. In particular, it relates to a finishing tool for use on edges, corners, and/or rounded surfaces of walls, edges, columns, archways, and other interior structures that require surface finishing.

2. Background

A variety of devices have been developed to assist workmen when finishing the exterior or interior of residential or commercial structures, when installing drywall, stucco, or plaster surfaces, or when repairing damage to pre-existing wall surfaces. Typically these devices take the form of relatively complicated structures that are designed to perform a single function, such as finishing a radius surface (e.g. a segment of a surface structure which has a curved angle, or a radius corner where two walls meet, or alternatively, a column). For example, many times a worker will spend endless hours trying to apply material, such as plaster, cement, drywall mode, etc., on a radius wall by pulling the material in a horizontal pattern on the wall or column to create a smoothed rounded surface. Unfortunately, workmen typically use the same flat tools that are used on a flat wall to finish radius surfaces and columns. Because of this, the finishing process will often create imperfections such as flat spots on the radius wall or columns. In order to correct this problem, workmen will repeatedly revisit the same surface area in an attempt to produce a proper finish. In turn, this results in undesired inefficiency and expense due to the loss of time which is caused by the use of a flat surface tool that is not efficient for floating a radius or curved surface. It would be desirable to have a single tool that is capable of floating not only flat surfaces, but also obtuse or curved angles such as those that occur at the surface edges of a room, such as those found where two walls or walls and ceilings come together, such as those surrounding portals or arches, such as those found on radius walls, or such as those found on columns.

A problem associated with construction and/or repair of building structures is the substantial amount of work related to properly finishing or repairing columns or radius (i.e. curved, or irregular) walls. These structures require substantial amounts of work to properly complete either installation or repair. It would be desirable to have tool capable of rapidly finishing irregular surfaces such as these to minimize the amount of time and money required to finish these special surfaces.

Modern construction practices use a variety of materials. In addition, structures may have a variety of surface types, with both flat and/or radius surfaces. Quite often, workmen's tools are designed to work with specific types of building materials and particular types of structures. This requires the workmen to possess and transport multiple types of tools. It would be desirable to have a single tool capable of working with any type of plaster, stucco, mortar or cement based material, and further capable of working with different surface structures. In addition, it would be desirable to have a tool which can rapidly float large radius surfaces without leaving flat spots or other undesirable imperfections.

### SUMMARY OF THE INVENTION

The present invention provides a surface finishing tool for floating columns and radius (e.g., curved or rounded) surfaces. The surface finishing tool is an extended flexible blade with handles at either end. The blade has a flat edge surface that can be held flat against a wall surface so that the plaster, spackle, or other material spread over drywall joints is properly smoothed prior to sanding and painting. In addition, the extended blade is sufficiently flexible to allow it to be deformed by pulling the handles toward the workmen, which allows the blade to be used to finish inner radius seams where two walls meet on a radius wall. The blade can also be deformed in the opposite direction to allow it to finish outer radius seams where two walls are joined by the radius seam, to finish irregular wall surfaces, or to finish columns. The blade provides a single foldable surface which allows radius surfaces to be finished without leaving flat spots. An alternative embodiment provides the ability to replace the extended blade with other blades having a variety of edge finishes. The edge finishes provide the workmen with the ability to rapidly create custom surface finishes on large walls.

### BRIEF DESCRIPTION OF THE DRAWINGS

FIG. 1 is a side surface view of a preferred embodiment of the surface finishing tool which illustrates the extended blade and the handles.

FIG. 2 is a front edge view of a preferred embodiment of the surface finishing tool which illustrates the flat front edge of the extended blade and the handles secured to the extended blade. In this view, the extended blade is in a linear orientation for treatment of flat surfaces.

FIG. 3 is a front edge view of a preferred embodiment of the surface finishing tool which illustrates the flat front edge of the extended blade and the handles secured to the extended blade. In this view, the extended blade is deformed for treatment of non-flat surfaces.

FIG. 4 is a side surface view of an alternative preferred embodiment of the surface finishing tool. This embodiment uses angled corners at the ends of the extended blade.

FIG. 5 is an exploded view of a handle and the end portion of an extended blade. This figure illustrates how a handle may be secured to an extended blade.

FIG. 6A illustrates an alternative preferred embodiment of the extended blade that uses a sawtooth pattern to produce a custom surface treatment effect.

FIG. 6B illustrates another alternative preferred embodiment of the extended blade that uses a wave pattern to produce a custom surface treatment effect.

FIG. 7A illustrates the extended blade that is deformed to allow finishing of an acute angle where two walls meet. This figure illustrates the blade positioned to create a smooth surface using finishing material.

FIG. 7B illustrates a radius corner created by the extended blade where two walls meet at an acute angle.

FIG. 7C illustrates a radius wall being finished by the extended blade.

FIG. 8 illustrates the extended blade that is deformed to allow floating an outer radius where two walls meet.

FIG. 9 is an edge view of a preferred embodiment of the finishing blade that illustrates the extended blade that is deformed while finishing a radius surface. In this case the surface is a column.

FIG. 10A is an alternative preferred embodiment of the extended blade that uses a removable sawtooth pattern to produce a custom surface treatment effect.

FIG. 10B another alternative preferred embodiment of the extended blade that uses a wave pattern to produce a custom surface treatment effect.

FIG. 10C is another alternative preferred embodiment of the extended blade that uses a rigid support to hold the blade in a linear configuration.

### DESCRIPTION OF THE PREFERRED EMBODIMENT

Prior to a detailed discussion of the figures, a general overview of the system will be presented. The invention provides a single tool that allows the workmen to perform several tasks. The tool is an extended flexible blade that the workman controls by grasping handles mounted on each end of the blade. Its primary function is to allow workmen to float surfaces in a rapid and high-quality manner.

As used in this specification, the term “float” is intended to mean the application of surface finishing material, such as plaster, cement, drywall mode, etc., to an unfinished surface. The surface finishing tool provided by this invention allows wall finishing material to be applied to large areas of the radius of the wall or column, and to do so with a smooth finish that does not have flat spots. As a result, the workmen can float a surface much more rapidly, because the surface finishing tool substantially reduces surface imperfections such as flat spots and eliminates the need for the workmen to repeatedly refinish a surface area to correct these imperfections. Prior to the invention of the surface finishing tool, imperfections in a wall surface, such as flat spots, holes, etc., the workman would use a conventional drywall knife and move the knife laterally across the surface. This technique produces imperfect results and typically requires a substantial amount of repetitive effort on the part of the workmen to complete the floating process. In contrast, the surface finishing tool can be moved across the surface laterally or vertically. In addition, due to its much larger size in relation to a drywall knife, the wall can be floated much faster with a substantial elimination of repetitive strokes.

Another unique advantage of this invention is that it allows the workmen to finish inner and outer radius surfaces with the same tool. It provides the workmen with greater convenience by reducing the number of hours needed to finish a particular job. In addition, it improves the workmen's productivity and reduces the contractor's expenses.

When installing or repairing walls in a structure, workmen will typically install drywall panels that are butted together. Once this process is completed, the drywall panels are taped and finishing materials such as plaster, stucco, etc. are used to cover the tape so that the wall gives the appearance of a continuous surface with no seams. In addition to the taped seams, the wall panels are also finished where a wall panel abuts another wall, or ceiling to form an angle. Likewise, the edges of portals, arches, etc. all require finishing prior to painting, application of wallpaper, etc. Some structures also have unique architectural features, such as columns, or radius walls. While conventional flat walls and straight portals edges are typically a fairly laborious process to finish, nonlinear surfaces such as radius walls and columns require substantial amounts of work to properly finish.

The flexible extended blade provided herein allows workmen to rapidly finish all of these surface types. For example, on flat surfaces, the extended blade can be held with its edge perpendicular to a flat wall to rapidly finish surface treatments on the flat portions of walls, such as tape plastering, stucco installation, etc.

When finishing a radius corner where two walls, or a wall and a ceiling join one another, the extended blade can be deformed by pulling the handles toward one another and toward the workmen such that the edge of the extended blade provides a smoothed curve which, when moved over finishing material such as plaster, will provide a smoothed radius finish to the corner where the wall surfaces meet.

Alternatively, when finishing an edge, such as that found in a portal, or entryway, the flexible blade can be deformed in the opposite direction to provide the edge with a smooth radius finish.

In addition to providing smooth finishes, the invention also allows workmen to rapidly create unique ornamental surfaces. This is accomplished by removing the handles from the extended blade, and reinstalling them on an extended blade with an alternative edge structure. In particular, the extended blades can take any number of unique shapes, which when dragged across the surface with material such as plaster, stucco, etc., will create unique ornamental patterns.

Having discussed the features and advantages of the invention in general, we turn now to a more detailed discussion of the figures.

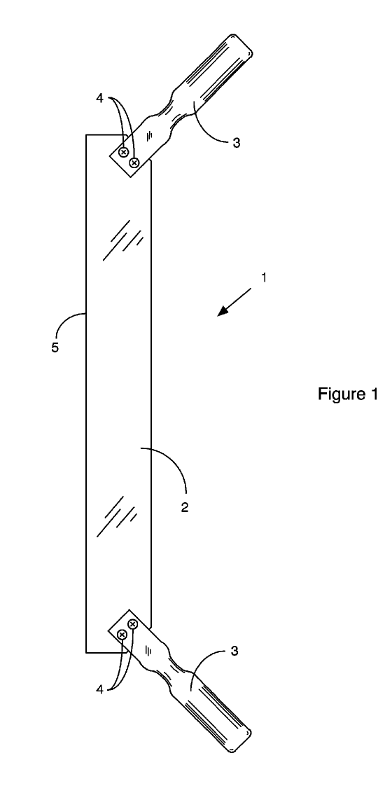

In FIG. 1, a top surface view of a preferred embodiment of the surface finishing tool 1 is shown. In this figure, a side view of the extended blade 2 is shown. The blade handles 3 are also shown secured to each end of the extended blade 2.

In the preferred embodiment, the blade handles 3 are attached to the extended blade 2 via blade mounting screws 4. Those skilled in the art will recognize that while blade mounting screws 4 are used in this embodiment, any suitable method of securing the blade handles 3 to the extended blade 2 can be used. Likewise, the preferred embodiment of the invention envisions that the blade handles 3 will be fabricated from inexpensive and reasonably comfortable material such as wood, plastic, etc. However, it is understood that any suitable material may be used to fabricate the blade handles 3 providing it is suitable for use in a construction environment.

The blade handles 3 are also shown mounted at an angle. This is done to provide an ergonomic handle position that can be easily grasped by workmen. The angle is not critical and can be anything that is suitable for the workmen's comfort. In addition, is possible to structure a handle such that the angle can be adjusted by an individual workman to suit the workman's taste. This can be done in a variety of manners, such as by using a slotted screw mount.

The extended blade 2 is preferably fabricated from stainless steel for several reasons. First, stainless steel is durable and will hold up well in a harsh environment where it is exposed to rough treatment. In addition, it is also resistant to water damage that also occurs in a construction environment. Those skilled in the art will also recognize that any number of other suitable materials may be used to fabricate the extended blade 2. The only requirement is that the material chosen is suitable for the environment in which the extended blade 2 will be used.

In the preferred embodiment, the extended blade 2 has dimensions of approximately 36 in. in length, 3 in. in width, and 1/16 of an inch in thickness. Again, these dimensions are not critical to the invention. For example, depending on the type of material used to fabricate the extended blade 2, the thickness can vary. It is, however, important to remember that a thickness needs to be selected which will allow the extended blade 2 to be deformed such that it can float radius corners and bend around edges and curves, and at the same time, it must have the ability to return to its original linear configuration when force is removed from the blade handles 3. Likewise, the length of the extended blade 2 can also vary. For example, a workmen may want to have an extended blade 2 with a shorter length depending on the type of work which is to be performed for a given work project. To that end, the ability to remove the blade handles 3 allows the workmen to have a variety of extended blades 2, each having a different length.

Also shown in this figure is blade edge 5, which is the portion of the extended blade 2 that is used to finish wall surface areas.

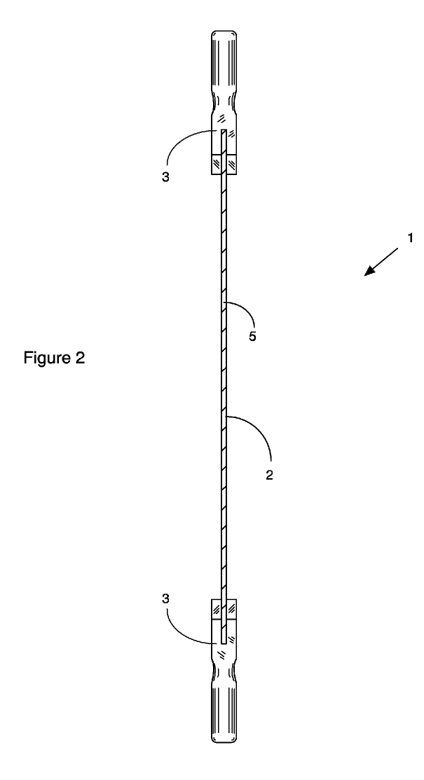

FIG. 2 is a front edge view of a preferred embodiment of the surface finishing tool 1. This figure illustrates the blade edge 5 of the extended blade 2 and the blade handles 3 secured to the extended blade 2. In this view, the extended blade 2 is in a linear orientation for floating flat surfaces, such as the central portions of walls or ceilings.

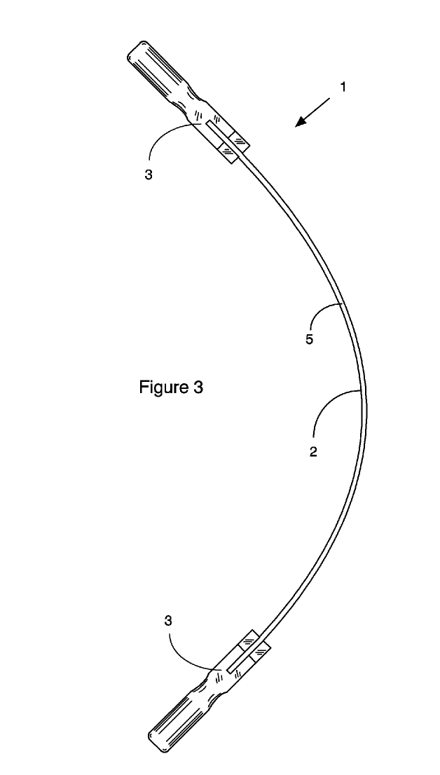

FIG. 3 is a front edge view of a preferred embodiment of the surface finishing tool 1 in a deformed configuration. This figure illustrates the blade handles 3 secured to the extended blade 2. This view illustrates how the extended blade 2 is deformed for treatment of non-flat surfaces. By pulling the blade handles 3 toward the workmen, or away from the workmen, the blade can be deformed such that it can be used on a radius surface having any type of angle.

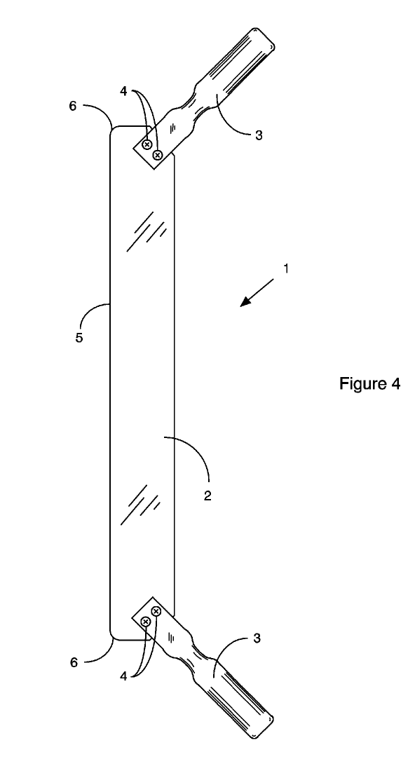

FIG. 4 is a side surface view of an alternative preferred embodiment of the surface finishing tool 1. In this embodiment, the extended blade 2 uses angled corners 6 at each end of the extended blade 2. The purpose of the angled corners 6 is to avoid any inadvertent scoring or marking of a wall surface by the edge of the extended blade 2 when it is moved across a wall surface.

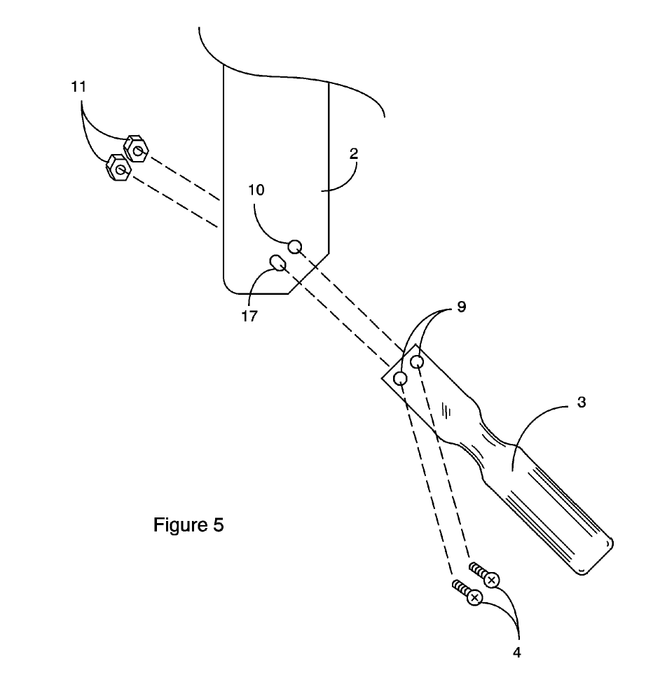

FIG. 5 is an exploded view of blade handle 3 and the end portion of extended blade 2. This figure illustrates how a blade handle 3 may be secured to an extended blade 2. In this figure, the dashed lines illustrate how blade mounting screws 4 are inserted through apertures 9 in the blade handle 3, through apertures 10 and optional slots 17 in the extended blade 2, and then secured by blade mounting nuts 11.

This figure illustrates optional slot 17. While the extended blade 2 can be fabricated by installing two identical apertures 10 in each end of the surface finishing tool 1, by using optional slot 17 instead of a second circular aperture 10, the workmen can adjust the angle of the blade handle 3 to a position that is more comfortable for the workmen. Those skilled in the art will recognize that the same result can be accomplished by using circular apertures in the extended blade 2, and using a slot in the blade handle 3.

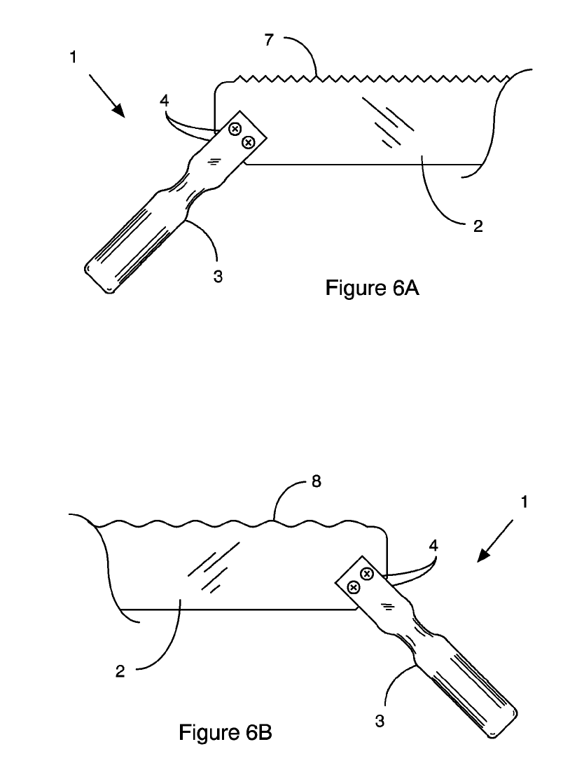

FIG. 6A-B illustrate alternative preferred embodiments of the extended blade 2 that use preselected custom edge patterns to produce desired surface treatment effects. The workmen can, by moving the surface finishing tool 1 in any desired motion pattern, create a variety of ornamental surface treatment effects.

FIG. 6A illustrates a preferred embodiment of the extended blade 2 that uses a sawtooth edge pattern 7. When the extended blade 2 is dragged across the surface of a wall, the workmen can create ornamental design patterns by moving the extended blade 2 in preselected directions.

FIG. 6B illustrates another alternative preferred embodiment of the extended blade 2 that uses a wave edge pattern 8 to produce a custom surface treatment effect in the same manner as was discussed in regard to FIG. 6A.

The foregoing custom edge patterns are for illustrative purposes only, and are not intended to limit the number of custom edge patterns that are possible. Those skilled in the art will recognize any number of custom edge patterns can be created to produce a wide variety of ornamental surface treatments.

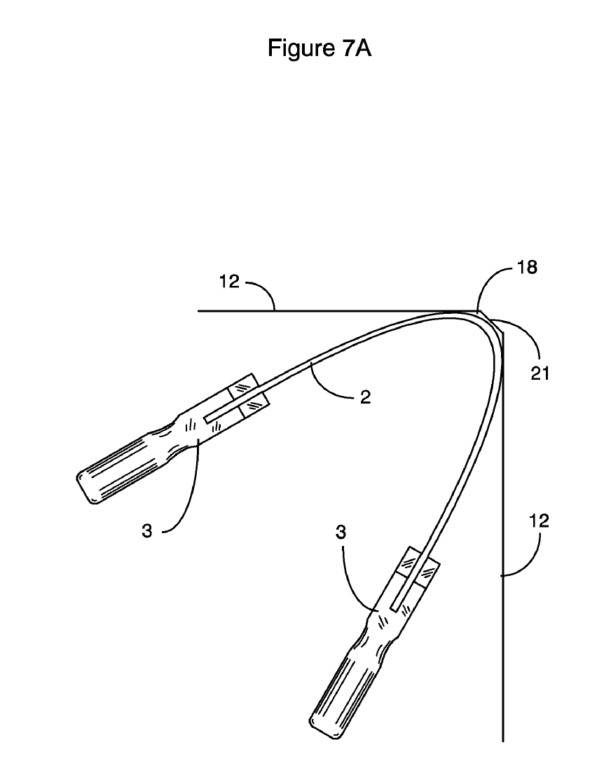

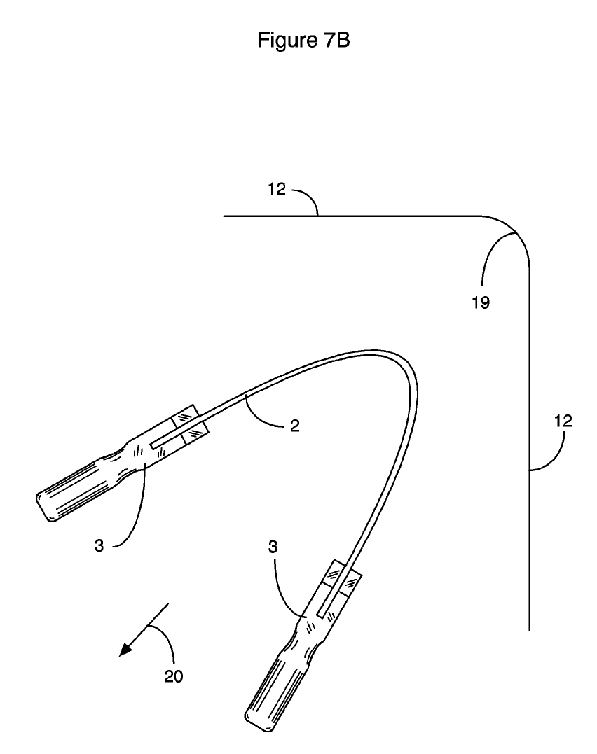

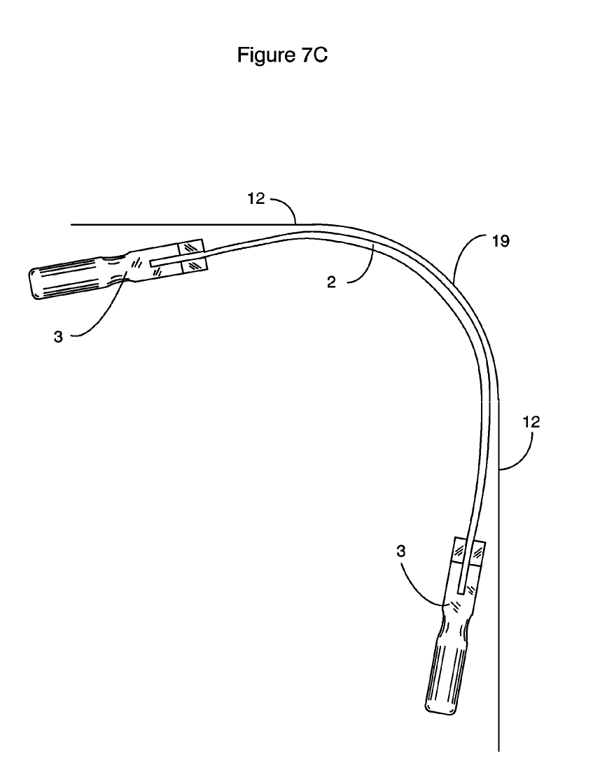

FIG. 7A illustrates a preferred embodiment of the extended blade 2 which is shown in a deformed configuration to allow finishing of a radius corner where two walls 12 meet at corner 21. In this configuration, the blade handles 3 are pulled together so that the extended blade 2 will form a smooth radius corner joining the walls 12. Plaster, or other finishing material 18 is first placed on the corner 21 and the surface finishing tool 1 is then moved along the corner 21 to create a smooth finish using finishing material 18.

In this illustration, corner 21 is formed by an angled panel which connects the adjoining walls 12. However, those skilled in the art will recognize that corner 21 may have one or more straight segments, or a radius segment, which extends between walls 12. The purpose of structuring corner 21 in this manner is to minimize the amount of finishing material which may be necessary to finish a radius corner 19 (as shown and discussed in regard to FIG. 7B, below). Of course, the corner 21 can also be formed by a curved underlayment and then floated with the surface finishing tool 1.

FIG. 7B illustrates a radius corner 19, which was created by applying finishing material 18 to the unfinished corner 21 and shaping it with the surface finishing tool 1, as illustrated in FIG. 7A, above. The surface finishing tool 1 is shown as it is moved, in direction 20, away from the radius corner 19.

While FIG. 7B illustrated the surface finishing tool 1 being used to finish a relatively small radius corner, FIG. 7C illustrates the ability of the surface finishing tool to finish a large radius wall.

As illustrated in FIGS. 7A-C, a particular advantage of the surface finishing tool 1 is that, due to its flexibility, it does not have the disadvantage of having to rely on a particular corner size. In fact, it can be flexed to suit any number of radius corner and radius wall sizes, so long as the surface finishing tool 1 has sufficient length. By flexibly adjusting the angle of the extended blade 2 to conform to existing structures, the surface finishing tool 1 can be used in situations where less-than-perfect construction quality exists. As can be seen, an advantage of the surface finishing tool 1 is that it can be flexed to suit any size of radius corner.

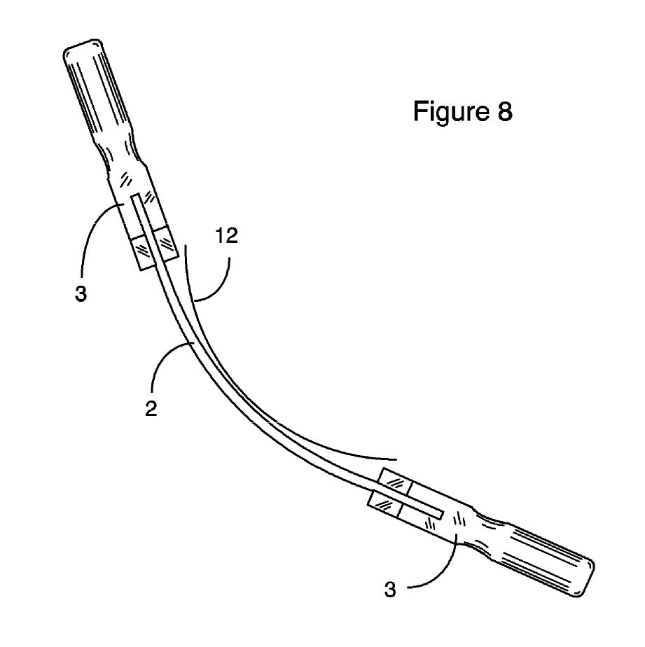

FIG. 8 illustrates a downward view of the surface finishing tool 1 being used to finish the edge of radius corner 12. This figure illustrates the opposite situation of that shown in FIG. 7. In this figure, the extended blade 2 is deformed in the opposite direction by moving the blade handles 3 away from the workmen. This allows the workmen to finish an obtuse angle where two walls 12 meet, such as that found in entryways, L-shaped rooms, etc. In this figure, the wall 12 has two flat portions connected by a radius wall. As the surface finishing tool 1 is dragged down the edge of the radius portion of wall 12, a smooth rounded finish is applied to the radius curve of wall 12.

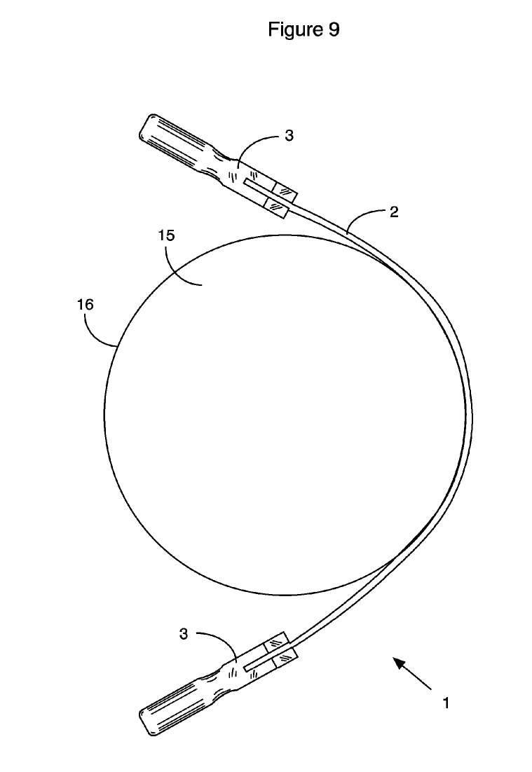

FIG. 9 is a downward view of a preferred embodiment of the surface finishing tool 1 that illustrates the extended blade 2 being used to finish the surface 16 of a column 15. As can be seen from this figure, surface finishing tool 1 provides a substantial advantage to the workman by allowing the workman to finish columns having any number of diameters. The workman merely the forms the extended blade 2 a sufficient amount such that it matches the diameter of the column 15.

Those skilled in the art will recognize that the same technique, discussed above in regard to FIG. 9, can be used to treat other curved surfaces, such as radius walls.

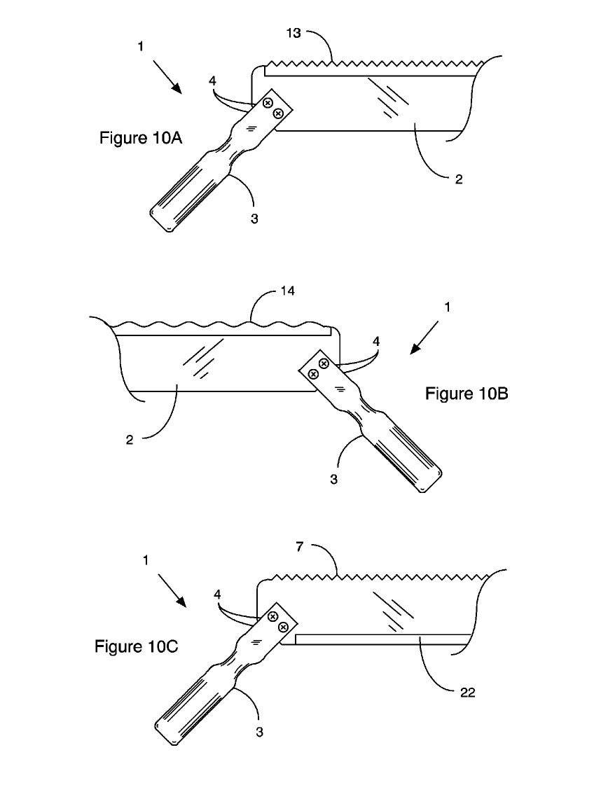

FIG. 10A illustrates an alternative preferred embodiment of the extended blade 2 that uses a removable sawtooth edge pattern 13. In this embodiment, the extended blade 2 can have a straight edge for normal use. When an unusual pattern is desired for finishing a surface, the workman only has to attach the removable sawtooth edge pattern 13 to the edge of the extended blade 2. In the preferred embodiment, the removable sawtooth edge pattern 13 would be secured to the extended blade 2 by a pressure fit clamp structure which is integrated into the removable sawtooth edge pattern 13, itself. Those skilled in the art will recognize that while a clamp structure is preferred, any suitable method of attaching the removable sawtooth edge pattern 13 can be used. When the extended blade 2 is dragged across the surface of a wall, the workmen can create custom ornamental design patterns by moving the extended blade 2 in selected directions.

FIG. 10B illustrates another alternative preferred embodiment of the extended blade 2 that uses a removable wave edge pattern 14 to produce a custom surface treatment effect in the same manner as was discussed in regard to FIG. 6A.

In addition, the removable edge patterns 13-14 can be rigid or flexible. The rigid edge patterns 13-14 would maintain the extended blade 2 in an unflexed, straight, orientation for use on large flat surfaces, while flexible edge pattern 13-14 would be used for radius surfaces.

FIG. 10C illustrates another preferred embodiment in which a rigid support brace 22 is secured to the extended blade 2. In the preferred embodiment, it is envisioned that the rigid support brace 22 would be a snap-on clamp that prevents the extended blade 2 from flexing. This would be used on a large flat surface which is to be floated. In this figure, a sawtooth edge 7 is illustrated for purposes of discussion. However, it is understood that any edge treatment, including a straight edge, can be used.

Of course, the foregoing custom edge patterns are for illustrative purposes only, and are not intended to limit the number of custom edge patterns that are possible. Those skilled in the art will recognize any number of custom edge patterns can be created to produce a wide variety of ornamental surface treatments.

As can be seen from the foregoing, the surface finishing tool 1 provides a substantial amount of flexibility to workmen by allowing the workmen to use a single tool on a wide variety of surfaces. It can be used to float flat surfaces, or float a radius surface having acute or obtuse angles. It eliminates the need for the workmen to cany multiple tools, thereby reducing the contractor's expense, and increasing the workmen's convenience. In addition, surface areas can be floated very rapidly using the surface finishing tool 1, thereby increasing the workmen's productivity and reducing the contractor's expense.

While the invention has been described with respect to a preferred embodiment thereof, it will be understood by those skilled in the art that various changes in detail may be made therein without departing from the spirit, scope, and teaching of the invention. For example, the material used to construct both the extended blade 2 and the blade handle 3 may be anything suitable for its purpose, the size and shape of the extended blade 2 and blade handle 3 can vary. The blade handle 3 can be removable or permanently attached. Extended blades 2 having a variety of sizes may be used to suit a workmen's taste. Likewise, the shape and number of custom edge patterns can vary, etc. Accordingly, the invention herein disclosed is to be limited only as specified in the following claims.

I claim:

1. A surface finishing tool for floating surfaces, further comprising:
an extended blade having a blade edge, a first end and a second end;
first and second blade handles, the first blade handle secured to the first end of the extended blade, and second blade handle secured to the second end of the extended blade;
the extended blade having sufficient flexibility such that it can be deformed when the first and second blade handles are moved closer in relation to one another, and the amount of deformation of the extended blade is controlled by the movement of the blade handles;
whereby the extended blade can be selectively deformed by moving to the blade handles.

2. A tool, as in claim 1, wherein:
the blade handles are removably attached to the extended blade.

3. A tool, as in claim 2, wherein:
the blade handles are attached to the extended blade at a preselected angle.

4. A tool, as in claim 3, further comprising:
at least one aperture in the extended blade aligned with an aperture in the blade handle such that the blade handle can be secured to the extended blade with a first screw;
at least one elongated slot in the extended blade, or the blade handle, such that the blade handle can be pivotably attached to the extended blade;
whereby the angle that the blade handle is attached to the extended blade can be adjusted.

5. A tool, as in claim 1, wherein:
the extended blade is approximately 36 inches in length.

6. A tool, as in claim 1, wherein:
the extended blade is fabricated from stainless steel.

7. A tool, as in claim 6, wherein:
the extended blade is approximately 1/16 inches thick.

8. A tool, as in claim 1, wherein:
the extended blade having sufficient flexibility and resilience to move to a non-linear orientation when pressure is applied to the blade handles, and returning to a linear configuration when pressure is not applied to the handles.

9. A tool, as in claim 1, wherein:
the blade handles are attached to the extended blade at a preselected angle.

10. A tool, as in claim 9, further comprising:
at least one aperture in the extended blade aligned with an aperture in the blade handle such that the blade handle can be secured to the extended blade with a first securing means;
at least one elongated slot in the extended blade, or the blade handle, such that the blade handle can be pivotably attached to the extended blade;
second securing means for attaching the extended blade to the blade handle at the elongated slot;
whereby the angle that the blade handle is attached to the extended blade can be adjusted.

11. A tool, as in claim 9, wherein:
the first and second ends of the extended blade have rounded corners.

12. A tool, as in claim 1, wherein:
the blade edge is substantially flat.

13. A tool, as in claim 1, wherein:
the blade edge has a custom edge pattern.

14. A tool, as in claim 1, wherein:
the extended blade and sufficient flexibility to conform to an inner or outer radius surface when deformed.

15. A tool, as in claim 14, wherein:
the extended blade is held in a straight configuration by a removable rigid support brace.

16. A tool, as in claim 15, wherein:
the extended blade has a removable predetermined edge pattern to form custom surface treatments.

17. A tool, as in claim 14, wherein:
the extended blade has a removable predetermined edge pattern to form custom surface treatments.

18. A method of floating a surface, including the following steps:
moving a wall finishing tool across a surface, the wall finishing tool having a flexible extended length blade, and a pair of handles attached to opposing ends of the flexible extended length blade; and
holding the wall finishing tool such that it is in a linear configuration when moving the wall finishing tool across a flat surface, and deforming the extended blade of the wall finishing tool when moving the wall finishing tool over a radius or curved surface;
whereby the wall finishing tool can be used to float flat or radius surfaces.

19. A method, as in claim 18, including the additional steps of:
creating ornamental surfaces on a wall or ceiling by using a blade edge having a variable edge configuration.

20. A method, as in claim 18, including the additional steps of:
providing sufficient flexibility in the extended blade such that it that provides a linear edge to finish flat surfaces, or when deformed, provides a curved structure to finish radius or curved surfaces.
